(19) United States
(12) Patent Application Publication
(10) Pub. No.: US 2012/0235565 A1
(43) Pub. Date: Sep. 20, 2012

(54) MAGNETRON AND APPARATUS THAT USES MICROWAVES

(75) Inventors: Takeshi Ishii, Shiga (JP); Nagisa Kuwahara, Shiga (JP)

(73) Assignee: PANASONIC CORPORATION, Kadoma-shi, Osaka (JP)

(21) Appl. No.: 13/512,798

(22) PCT Filed: Nov. 30, 2010
(86) PCT No.: PCT/JP2010/006986

§ 371 Date: May 30, 2012

(30) Foreign Application Priority Data
Nov. 30, 2009 (JP) 2009-272336

(51) Int. Cl. H01J 25/50

(52) U.S. Cl. 315/39.51

(57) ABSTRACT

The magnetron includes: an exhaust pipe in which an antenna is disposed in a vacuum-sealed space, and which extends along the central axis of the antenna; an insulation tube which extends along the central axis of the antenna, and of which one end is fixed to the exhaust pipe by brazing; and an antenna cap including a bottom portion and a tubular portion which is continuous with the bottom portion to extend along the axis of the antenna and of which a diameter on an open end side is larger than a diameter of the exhaust pipe. The tubular portion of the antenna cap covers: a brazed portion where the exhaust pipe and the insulation tube are brazed to each other; and a metalized portion.

### TECHNICAL FIELD

The present invention relates to a magnetron and an apparatus that uses microwaves, and more particularly to a magnetron which is to be used in an apparatus that uses microwaves, such as a microwave oven.

### BACKGROUND ART

Referring to FIG. 4, main portions of a conventional magnetron 100 will be described. FIG. 4 is an enlarged view of main portions of the conventional magnetron 100. In the conventional magnetron 100 shown in FIG. 4, an annular thin metal plate 101 is positioned in a vacuum-sealed closed space S1 of the magnetron 100, and between a brazed portion 103 in which an output side insulated conductor 107 is brazed and fixed to a cover portion 109a of a sealing metal 109, and an antenna conductor 105 which is disposed in the vacuum-sealed closed space S1. The annular thin metal plate 101 prevents discharge generated between the brazed portion 103 and the antenna conductor 105, in the vacuum-sealed closed space S1 of the magnetron 100 (See Patent Document 1). Here, the brazed portion 103 includes a metalized layer 103b in which a metalizing process is performed on a lower portion of the output side insulated conductor 107, and a convex portion 103a of a brazing material which is attached in brazing.

In the conventional magnetron 100, a choking structure is used as means for suppressing harmonics, and is formed in the closed space S1 formed in a vacuum pipe.

### RELATED ART DOCUMENTS

### Patent Documents

Patent Document 1: JP-Y2-4-46362

### SUMMARY OF THE INVENTION

### Problem to be Solved by the Invention

In the configuration of the magnetron 100 shown in FIG. 4, although discharge can be prevented in the vacuum-sealed closed space S1, however, it is not possible to prevent discharge generated at the portion which extends to the outside of the vacuum-sealed closed space S1, such as the metalized layer 103b and convex portion 103a of the brazing material which are included in the brazed portion 103.

A conventional magnetron configuration has a choking function against harmonics depending on the shape of an exhaust pipe or the length to a vacuum-sealed portion. In a magnetron in which a vacuum sealing process has been once performed, it is very difficult to conduct a later adjustment.

An object of the invention is to provide a magnetron and an apparatus that uses microwaves, which can prevent discharge generated outside a vacuum-sealed closed space in a brazed portion and metalized portion which are formed by a part of the configuration of the magnetron, and which can adjust a choking function against harmonics by the shape of an antenna cap of an external fitting structure for the vacuum-sealed closed space.

### Means for Solving the Problem

The present invention provides a magnetron including: an exhaust pipe in which an antenna is disposed inside a vacuum-sealed space, and which extends along a central axis of the antenna; an insulation tube which extends along the central axis of the antenna, and of which one end is fixed to the exhaust pipe by brazing; and an antenna cap including: a bottom portion; and a tubular portion which is continuous with the bottom portion to extend along the axis of the antenna, and of which a diameter on an open end side is larger than a diameter of the insulation tube, wherein the tubular portion of the antenna cap covers: a brazed portion where the exhaust pipe and the insulation tube are brazed to each other; and a metalized portion.

In the magnetron described above, the tubular portion includes: a first tubular portion which is continuous with the bottom portion, and which extends along the axis of the antenna; and a second tubular portion which is continuous with the first tubular portion, and which has a diameter larger than the diameter of the insulation tube, and the first tubular portion and the second tubular portion, as well as the bottom portion, cover: the exhaust pipe; and the brazed portion where the exhaust pipe and the insulation tube are brazed to each other.

The present invention provides an apparatus that uses microwaves including the magnetron according to claim 1 or 2.

### Advantages of the Invention

The magnetron and the apparatus that uses microwaves of the present invention can prevent discharge generated outside a vacuum-sealed closed space in a brazed portion and metalized portion which are formed by a part of the configuration of the magnetron.

Further, the magnetron and the apparatus that uses microwaves of the present invention can adjust an amount of harmonics leakage after vacuum sealing process.

### BRIEF DESCRIPTION OF THE DRAWINGS

FIG. 1 is a view of the whole configuration of a magnetron 1 of an embodiment of the invention.

FIG. 2 is an enlarged view of main portions of the magnetron 1 shown in FIG. 1.

FIG. 3(a) is a sectional view of an antenna cap 35, and FIG. 3(b) is a plan view (schematic view).

FIG. 4 is an enlarged view of main portions of a conventional magnetron 100.

### MODE FOR CARRYING OUT THE INVENTION

Hereinafter, an embodiment of the invention will be described with reference to the drawings.

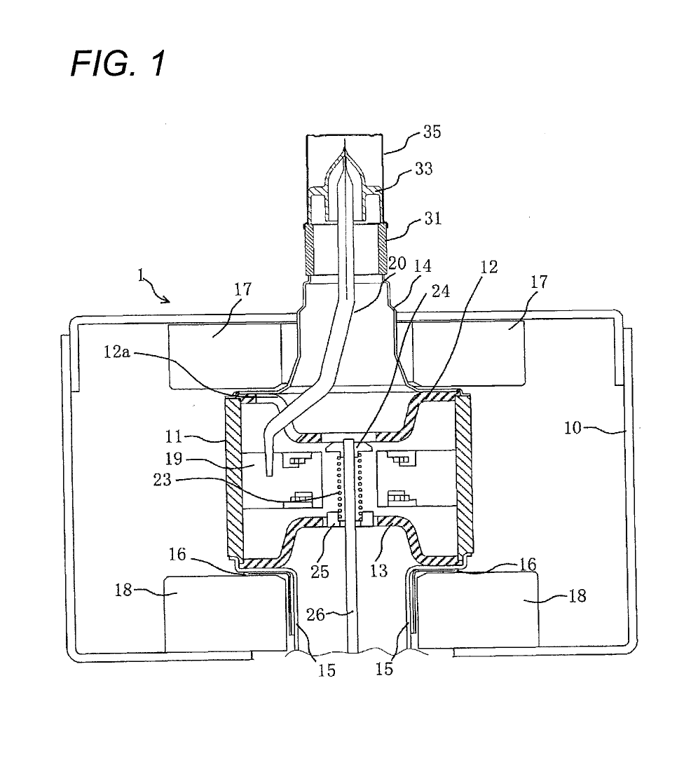

Referring to FIG. 1, portions constituting a magnetron 1 of the embodiment will be described. FIG. 1 is a view showing the whole configuration of the magnetron 1 of the embodiment. The magnetron 1 shown in FIG. 1 has: a magnetic yoke 10; an anode tube 11; an output side pole piece 12 which is coupled to an upper end opening of the anode tube 11; an input side pole piece 13 which is coupled to a lower end opening of the anode tube 11; an anode side tube 14 which covers the output side pole piece 12, and which is hermetically coupled to the upper end opening of the anode tube 11; a cathode side tube 15 which covers the input side pole piece 13, and which is hermetically coupled to the lower end opening of the anode tube 11; an annular magnet 17 which is placed inside the magnetic yoke 10 so as to be inserted into the anode side tube 14 immediately above the anode tube 11; and an annular magnet 18 which is placed inside the magnetic yoke 10 so as to be inserted into the cathode side tube 15 immediately below the anode tube 11.

The magnetron 1 of the embodiment further includes: an insulation tube 31 which is connected to the anode side tube 14 above the anode side tube 14; an exhaust pipe 33 which is brazed and fixed to the upper surface of the insulation tube 31; and an antenna cap 35 which externally covers parts of the exhaust pipe 33 and the insulation tube 31. The detail configuration will be described later.

The inside of the anode tube 11 is provided with a spiral cathode filament 23, a center lead 26 which supports the cathode filament 23, a plurality of anode vanes 19, and an output antenna 20 which upward extends from one anode vane 19 along the central axis of the anode tube 11. The plurality of anode vanes 19 are placed at predetermined intervals along the inner peripheral surface of the anode tube 11.

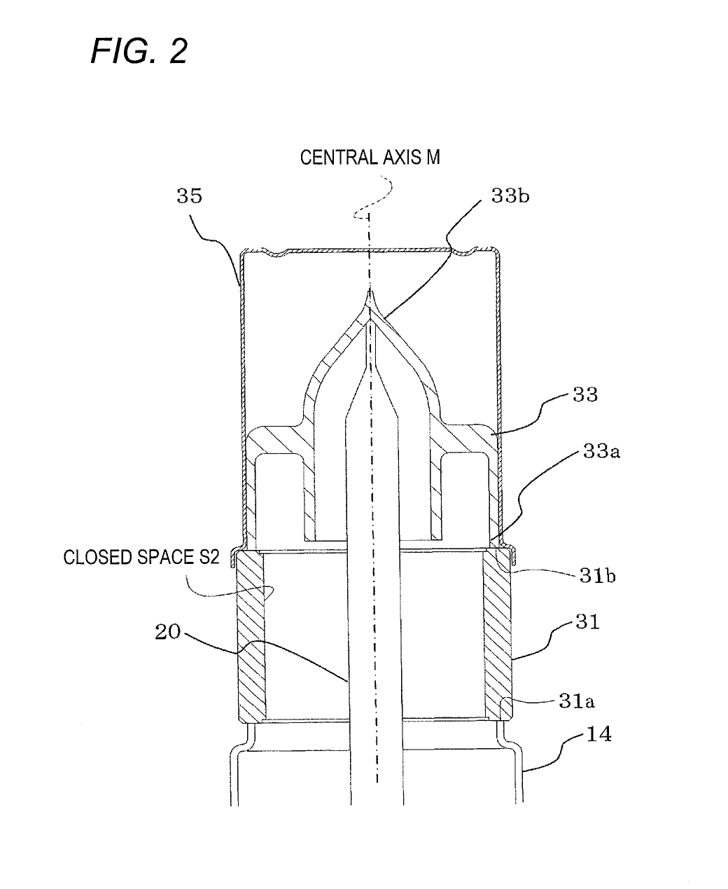

The output antenna 20 extends from the one anode vane 19 toward the output side pole piece 12 which is coupled to the upper end opening of the anode tube 11. The output antenna 20 further extends along the central axis M (see FIG. 2) of the anode tube 11 to one end of the exhaust pipe 33, through a hole 12a formed in a portion of an inclined wall of the output side pole piece 12, and inside the anode side tube 14, the insulation tube 31, and the exhaust pipe 33.

The spiral cathode filament 23 extends from an upper end shield 24 to a lower end shield 25 along the central axis of the anode tube 11. One end of the cathode filament 23 is fixed to the upper end shield 24, and the other end of the cathode filament 23 is fixed to the lower end shield 25.

The center lead 26 extends from the upper end shield 24 to a stem which is not shown, inside the cathode filament 23. The center lead 26 is fixed to the upper end shield 24, and supports the cathode filament 23.

Next, portions of the magnetron which are above the anode side tube 14 will be described in detail with reference to FIG. 2. FIG. 2 is an enlarged view of main portions of the magnetron 1 shown in FIG. 1.

The insulation tube 31 is a tubular member, and formed by ceramics. In the insulation tube 31, one end 31a in which a metalizing process is performed is hermetically coupled to the anode side tube 14, and the other end 31b in which a metalizing process is performed is hermetically coupled to one end 33a of the exhaust pipe 33. The one end 33a of the exhaust pipe 33 is fixed by brazing to the other end 31b.

In the description, hereinafter, the end portions (31a, 31b) of the insulation tube 31 in which a metalizing process is performed are sometimes referred to as the metalized portions. In the description, the portion which is in the other end 31 b of the insulation tube 31 or the one end 33a of the exhaust pipe 33, and which is brazed is sometimes referred to as the brazed portion.

In the area above the anode side tube 14 of the magnetron 1, a vacuum-sealed closed space S2 is formed inside the insulation tube 31 and the exhaust pipe 33. The brazed portion is formed while extending from the inside of the vacuum-sealed closed space S2 to the outside.

The one end 33a of the exhaust pipe 33 is brazed and fixed to the other end (the metalized portion) 31b of the insulation tube 31. The other end 33b of the exhaust pipe 33 is coupled to the tip end of the output antenna 20, and closed in order to vacuum seal the inside of the exhaust pipe 33. In the description, hereinafter, the other end 33b of the exhaust pipe 33 is sometimes referred to as the vacuum-sealed portion.

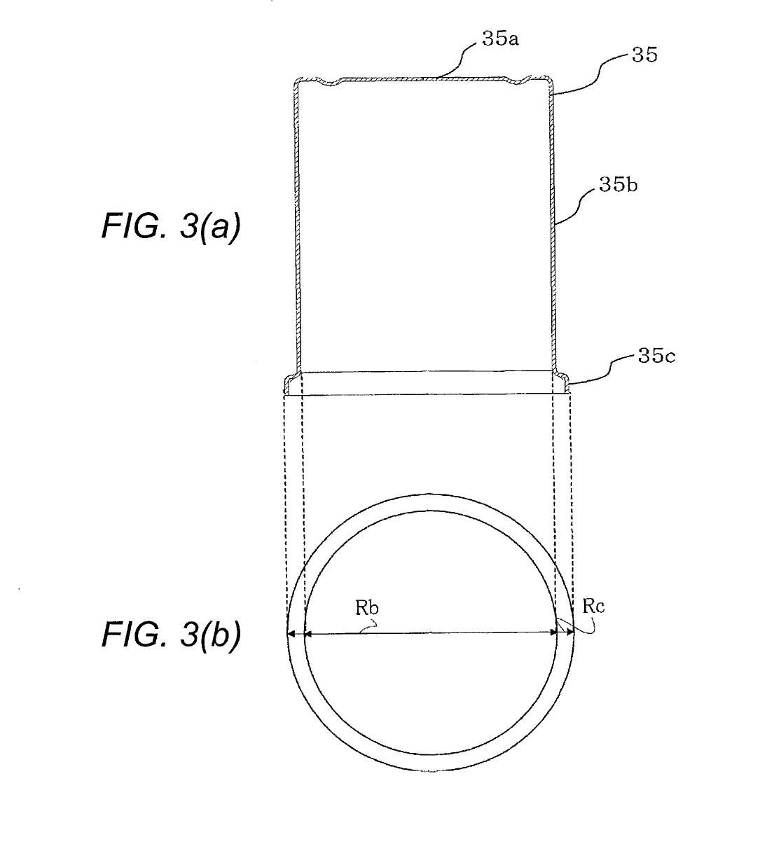

Here, the configuration of the antenna cap 35 which is one feature of the invention will be described with reference to FIGS. 2 and 3. FIG. 2 is an enlarged view of main portions of the magnetron 1 shown in FIG. 1. FIG. 3(a) is a sectional view of the antenna cap 35, and FIG. 3(b) is a plan view (schematic view) of it.

As shown in FIG. 2, the antenna cap 35 has a bottomed cylindrical shape which extends along the central axis of the output antenna 20, and its diameter is increased at the open end.

As shown in FIGS. 3(a) and 3(b), the antenna cap 35 further has: a circular bottom portion 35a; a first tubular portion 35b which is continuous with the bottom portion 35a, and which forms the side surface of the antenna cap 35; and a second tubular portion 35c which is continuous with the first tubular portion 35b, and which forms the side surface of the antenna cap 35. The first tubular portion 35b has a diameter Rb which is substantially equal to the outer diameter of the exhaust pipe 33, but the second tubular portion 35c has a diameter Rc which is slightly larger than the diameter of the insulation tube 31 in order to externally cover the other end 31 b of the insulation tube 31.

After the other end 33b of the exhaust pipe 33 is vacuum sealed to enter a closed state, the antenna cap 35 is attached toward the one end 31a of the insulation tube 31 so as to externally cover the vacuum-sealed portion of the exhaust pipe 33 (the other end 33b of the exhaust pipe 33). The antenna cap 35 shown in FIG. 2 is in the state which is obtained after the antenna cap is attached toward the one end 31a of the insulation tube 31 so as to externally cover the vacuum-sealed portion of the exhaust pipe 33 (the other end 33b of the exhaust pipe 33).

In the state where the antenna cap 35 is attached to the one end 31a of the insulation tube 31, as shown in FIG. 2, the antenna cap 35 externally covers the exhaust pipe 33 by the bottom portion 35a and the first tubular portion 35b, and externally covers the other end (the metalized portion) 31b of the insulation tube 31 by the second tubular portion 35c. Therefore, the antenna cap 35 covers the portion (the brazed portion) which is in the other end 31b of the insulation tube 31 or the one end 33a of the exhaust pipe 33, and which is brazed, thereby preventing the brazed portion and the metalized portion from being exposed to the outside of the magnetron 1.

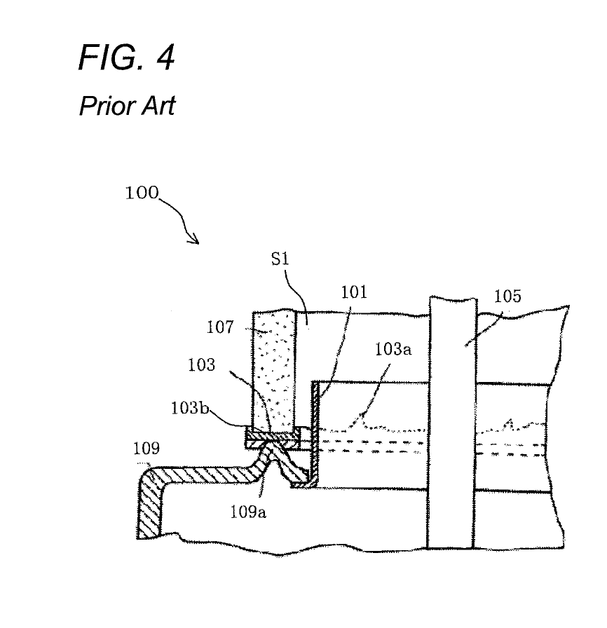

Here, the magnetron 1 of the embodiment is compared with the conventional magnetron 100 shown in FIG. 4. In the conventional magnetron 100 shown in FIG. 4, the portions which extend to the outside of the vacuum-sealed closed space S1, such as the metalized layer 103b and convex portion 103a of the brazing material which are included in the brazed portion 103 are not covered by any other member, and are exposed to the outside of the magnetron 100. In the magnetron 1 of the embodiment, by contrast, as described above, the antenna cap 35 covers the portion (the brazed portion) which is in the other end 31b of the insulation tube 31 or the one end 33a of the exhaust pipe 33, and which is brazed, thereby preventing the brazed portion and the metalized portion from being exposed to the outside of the magnetron 1.

Therefore, the antenna cap 35 of the magnetron 1 of the embodiment prevents the brazed portion and the metalized portion from being exposed to the outside of the magnetron 1, by covering the portion (the brazed portion and the metalized portion) which is in the other end 31b of the insulation tube 31 or the one end 33a of the exhaust pipe 33, and which is brazed, and can prevent discharge which may be triggered by a high electric field applied to a needle-like projection in the brazed portion or the metalized portion, and which may be generated toward the outside of the magnetron 1, from occurring.

Moreover, a resonant cavity configured by a shape defined from the one end 33a brazed with the insulation tube 31 to the second tubular portion 35c of the antenna cap 35 can suppress leakage of microwaves of a frequency band having an approximately ¼ wavelength which travels from the antenna 20 along the inner surface of the exhaust pipe 33 through the other end 33b of the exhaust pipe 33. Therefore, the applied frequency band can be adjusted by adjusting the length of the second tubular portion 35c of the antenna cap 35.

When the magnetron 1 of the embodiment is applied to a microwave oven which is an example of an apparatus that uses microwaves, the effective electrical length of microwaves in the coaxial waveguide conversion becomes longer with respect to a waveguide of the microwave oven, and the insertion length into the waveguide of the microwave oven can be apparently shortened. Therefore, the degree of freedom in design of the waveguide of the microwave oven can be increased.

In the magnetron 1 of the embodiment, it has been described that the antenna cap 35 has a cylindrical shape which extends along the central axis of the output antenna 20. However, the invention is not limited thereto. The shape can be arbitrarily designed in accordance with the shape of the insulation tube 31.

Although various embodiments of the invention have been described, the invention is not limited to the matters disclosed in the above-described embodiment. In the invention, it is expected that those skilled in the art will change or apply the matters based on the description in the description and the well-known technique, and such a change or application is included in the range to be protected.

The application is based on Japanese Patent Application (No. 2009-272336) filed Nov. 30, 2009, and its disclosure is incorporated herein by reference.

### INDUSTRIAL APPLICABILITY

The magnetron and apparatus that uses microwaves of the invention have an effect that discharge generated outside a vacuum-sealed space is prevented from occurring in a brazed portion and metalized portion that are formed by a part of the configuration of the magnetron, and is useful as an apparatus that uses microwaves or the like.

### DESCRIPTION OF REFERENCE SIGNS

1 Magnetron
20 Output Antenna
31 Insulation Tube
33 Exhaust Pipe
35 Antenna Cap
35a Bottom Portion
35b First Tubular Portion
35c Second Tubular Portion

1. A magnetron comprising:
an exhaust pipe in which an antenna is disposed inside a vacuum-sealed space, and which extends along a central axis of the antenna;
an insulation tube which extends along the central axis of the antenna, and of which one end is fixed to the exhaust pipe by brazing; and
an antenna cap comprising:
a bottom portion; and
a tubular portion which is continuous with the bottom portion to extend along the axis of the antenna, and of which a diameter on an open end side is larger than a diameter of the insulation tube,
wherein the tubular portion of the antenna cap covers: a brazed portion where the exhaust pipe and the insulation tube are brazed to each other; and a metalized portion.

2. The magnetron according to claim 1,
wherein the tubular portion comprises:
a first tubular portion which is continuous with the bottom portion, and which extends along the axis of the antenna; and
a second tubular portion which is continuous with the first tubular portion, and which has a diameter larger than the diameter of the insulation tube, and
wherein the first tubular portion and the second tubular portion, as well as the bottom portion, cover: the exhaust pipe; and the brazed portion where the exhaust pipe and the insulation tube are brazed to each other.

3. An apparatus that uses microwaves comprising the magnetron according to claim 1.
